(19) United States
(12) Patent Application Publication
(10) Pub. No.: US 2005/0216637 A1
(43) Pub. Date: Sep. 29, 2005

(54) Detecting coherency protocol mode in a virtual bus interface

(76) Inventors: Zachary Steven Smith, Fort Collins, CO (US); John Warren Maly, Laporte, CO (US); Ryan Clarence Thompson, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/806,729

(22) Filed: Mar. 23, 2004

(51) Int. Cl. G06F 12/00

(52) U.S. Cl. 710/305; 711/141; 711/146

(57) ABSTRACT

Systems, methodologies, media, and other embodiments associated with detecting a cache coherency protocol mode associated with a system that provided a point-to-point transaction to a virtual bus interface are described. One exemplary system embodiment includes a detection logic that facilitates identifying the cache coherency protocol mode. The exemplary system embodiment may also include a coding logic that facilitates selectively processing packets associated with a point-to-point transaction into a bus model transaction, where the packet processing depends, at least in part, on the cache coherency protocol mode.

### BACKGROUND

Processors in multi-processing systems may employ memory caches to temporarily store local copies of data. For example, a data line may be copied from a primary memory to a cache in a processor. Since data lines may be copied to more than one cache, some processor memory caches may contain inconsistent data from time to time. To address this consistency problem, multi-processing systems may employ a cache coherence protocol(s) designed to make data reads return valid data. The cache coherence protocols facilitate ensuring that when a processor reads a memory location it receives the correct value.

Two different types of coherence protocols are “snooping” coherence protocols and directory based coherence protocols. A snooping coherence protocol generally requires processors to be connected via a communication network medium that supports broadcasting and for processors to be able to listen to the network medium at all times. These two conditions suggest a shared bus configuration, although a snooping protocol may be employed in a point-to-point linked system. A directory coherence protocol involves having processors ask a directory for permission before loading an entry from primary memory to cache memory. Asking for permission may include a processor querying a directory that stores information concerning which cache(s) contains which entries. In a directory-based system, broadcast capability is not necessary, and thus other non-bus network mediums are suggested, although a directory-based system may be employed in a bus configuration.

Computer systems like multi-processing systems may include computer components that are operably connected together. These computer components may be operably connected by, for example, a bus and/or a port(s) into point-to-point (P2P) links. Components that are operably connected by a bus typically “listen” to substantially every request placed on the bus and “hear” substantially every response on the bus making them suitable for a snooping coherence protocol. To facilitate listening, hearing, and the like, various bus communication techniques, timings, protocols, transaction formats, and so on evolved. Thus, a transaction like a coherence transaction in a bus model system may include producing and monitoring various phases (e.g., arbitration, requests, snooping, data) and sending/receiving various signals during these phases.

Computer systems that are operably connected by P2P links operate substantially differently than those connected by a bus. Requests and responses are routed more exclusively (e.g., unicast) between sending and receiving components. Thus, less than all the operably connected computer components may encounter packets associated with a transaction. Additionally, the actions taken to send, receive, and/or route packets to perform a P2P transaction like a cache coherence transaction may be different than the actions taken to perform a corresponding bus model cache coherence transaction.

Since both bus connected systems and P2P connected systems have strengths and weaknesses it is not surprising that some computer systems are bus configured while others are P2P configured. In some examples, a hybrid multi-processing system may even include components that are connected using both P2P and bus methods. Similarly, since both snooping and directory-based cache coherence protocols have strengths and weaknesses, it is not surprising that some systems are snooping based while others are directory-based. Over the years, tools emerged for designing, analyzing, testing, and so on the different types of systems. Since the different types of systems are fundamentally different, a tool known as a virtual bus interface (VBI) was developed to facilitate correlating and/or comparing results from these tools. Additionally, since hybrid multi-processing systems may include components that are bus connected and P2P connected, a VBI was produced to facilitate communication between the components by producing bus-type transactions from P2P transactions and vice versa.

As described above, the conceptual and logical structure of P2P transactions differs fundamentally from that of bus transactions. In some cases there may not be a one-to-one semantic mapping between P2P transactions and bus transactions. Similarly, snooping cache coherence protocols and directory cache coherence protocols are fundamentally different. Thus, once again, there may not be a one-to-one semantic mapping between snooping cache coherence transactions and directory cache coherence transactions. Thus, the task of a VBI may include not only accounting for differences due to transaction semantics related to connection type (e.g., P2P, bus) but also due to coherence protocol type (e.g., snooping, directory).

### BRIEF DESCRIPTION OF THE DRAWINGS

The accompanying drawings, which are incorporated in and constitute a part of the specification, illustrate various example systems, methods, and so on that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an example bus model configuration of components.

FIG. 2 illustrates an example P2P model configuration of components.

FIG. 3 illustrates an example system for detecting a coherency protocol mode on a packet-by-packet basis.

FIG. 4 illustrates an example system for detecting a coherency protocol mode on a packet-by-packet basis.

FIG. 5 illustrates an example method for detecting a coherency protocol mode on a packet-by-packet basis in a VBI.

FIG. 6 illustrates a portion of an example method for detecting a coherency protocol mode on a packet-by-packet basis in a VBI.

FIG. 7 illustrates an example multiprocessing environment in which bus model linked and P2P model linked components may interact.

FIG. 8 illustrates an example computing environment in which example systems and methods illustrated herein can operate.

FIG. 9 illustrates an example application programming interface (API).

FIG. 10 illustrates an example P6 multiprocessor system with a front-side bus configuration.

FIG. 11 illustrates an example method for processing a packet based on a determined cache coherency protocol.

### DETAILED DESCRIPTION

Example systems and methods described herein interact with a VBI that produces bus-type transactions from P2P transactions. Since a system producing P2P transactions may employ a different cache coherence protocol than a system producing bus-type transactions, the VBI may be reconfigured to detect a coherency protocol mode (e.g., snooping, directory) on a packet-by-packet basis and to selectively alter whether and/or how bus-type transactions are produced based on the detected coherency protocol mode.

P2P transactions may flow differently depending on whether the P2P system is employing a directory cache coherence protocol or a snooping cache coherence protocol. For example, a self-snoop request may not exhibit self-snooping behavior in a directory system because coherency information can be retrieved from the directory. In a snooping system, a simple memory agent (SMA) may send the requesting agent a self-snoop request when that agent initiates a self-snoop type transaction. In a directory system, the SMA may retrieve the information from the directory and thus not query the agent. Example systems and methods may therefore detect transactions that may behave differently based on the cache coherence protocol and then process the transaction appropriately based, at least in part, on the cache coherence protocol detected.

Thus, in one example, in a VBI transaction tracking logic, self-snoop type transaction requests are treated as their non-self-snooping counterpart, which assumes that a directory system is in place, until a self-snoop request from an SMA arrives, which identifies that the system is in snooping mode and not directory mode. Upon receiving the self-snoop request back from the SMA, the VBI tracking logic will prepare itself to look for packets that indicate that the self-snoop request completed. Receiving back the self-snoop request reveals that the system is in snooping rather than directory mode.

A snooping cache coherence protocol relies on caches monitoring connections between processors and memory. Coherence is maintained by having cache controllers observe and monitor memory transactions. A snooping cache controller may take an action if a transaction involves a memory block stored in its cache. While a snooping cache coherence protocol facilitates quickly obtaining data, it tends to consume a relatively large amount of bandwidth due to the broadcast nature of snooping cache coherence requests.

A directory cache coherence protocol relieves the processor caches from snooping on memory requests by having a directory track which caches hold which memory blocks. A directory may, for example, have one entry per memory block. The entry may store, for example, a presence bit for processor caches and a state bit that indicates whether a block is not cached, stored in exactly one cache, or stored in two or more caches. Since the directory tracks which nodes have copies of a memory block, the need for a broadcast is eliminated.

A VBI may be used, for example, in processor design to facilitate correlating and/or verifying simulation tool actions. A first processor design tool like a bus model register transfer language simulation tool may be available. A second processor design tool like a higher level language P2P link model simulator may also be available. A VBI may facilitate comparing the outputs of the processor design tools. Transforming transactions from one model (e.g., P2P system) to another model (e.g., bus system) may be further complicated if one model employs a first cache coherence protocol (e.g., directory) while another model employs a second cache coherence protocol (e.g., snooping). By way of illustration, packets associated with a system using a directory protocol may have no corresponding packets for a related cache coherence transaction in a system using a snooping protocol. By way of further illustration, a cache coherence transaction from a system using a directory protocol may take actions not performed for a related cache coherence transaction in a system using a snooping protocol. For example, a self snoop request generated by a processor using a directory mechanism may not yield a self snoop request being presented to the initiating processor while the same self snoop request in a snooping model would yield a returned self snoop from agent request. Thus, whether a VBI tracking logic enters a certain state (e.g., snoop from memory agent) may depend on the cache coherency protocol in place. To avoid situations like waiting for a state machine to enter a state that will never be entered, entering a state that should not be entered, encountering an unexpected state, and so on, a VBI and/or a related system can be configured to determine cache coherency protocol on a packet-by-packet basis. Furthermore, in response to determining the cache coherency protocol, the VBI may alter its transaction tracking and/or transaction processing actions. Previously, a VBI may have assumed, at times incorrectly, that a certain cache coherency mechanism was being employed.

The following includes definitions of selected terms employed herein. The definitions include various examples and/or forms of components that fall within the scope of a term and that may be used for implementation. The examples are not intended to be limiting. Both singular and plural forms of terms may be within the definitions.

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and a computer. By way of illustration, both an application running on a server and the server can be computer components. One or more computer components can reside within a process and/or thread of execution and a computer component can be localized on one computer and/or distributed between two or more computers.

“Computer-readable medium”, as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks and so on. Volatile media may include, for example, optical or magnetic disks, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic medium, a CD-ROM, other optical medium, punch cards, paper tape, other physical medium with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

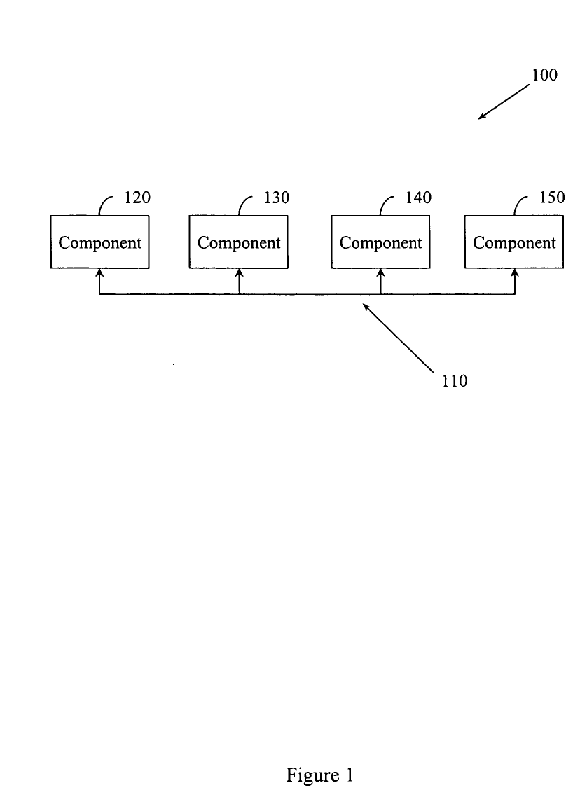

FIG. 1 illustrates an example set of computer components 100 connected by a bus 110. Bus 110, (e.g., a front-side bus), may connect computer components 120, 130, 140, and 150 which may be, for example, processors in a multiprocessor system. While four components are illustrated, it is to be appreciated that a greater and/or lesser number of components may be connected. The processors may include memory caches and thus a cache coherence protocol may be employed to keep data consistent between the processors. A cache coherency transaction on bus 110 may include, for example, fundamental parts like a request and a response. The request may transmit a request to be serviced and the response may complete or defer the transaction. Thus, in a bus-model, a transaction may be thought of as a set of bus activities that relate to a single bus operation like a read or write.

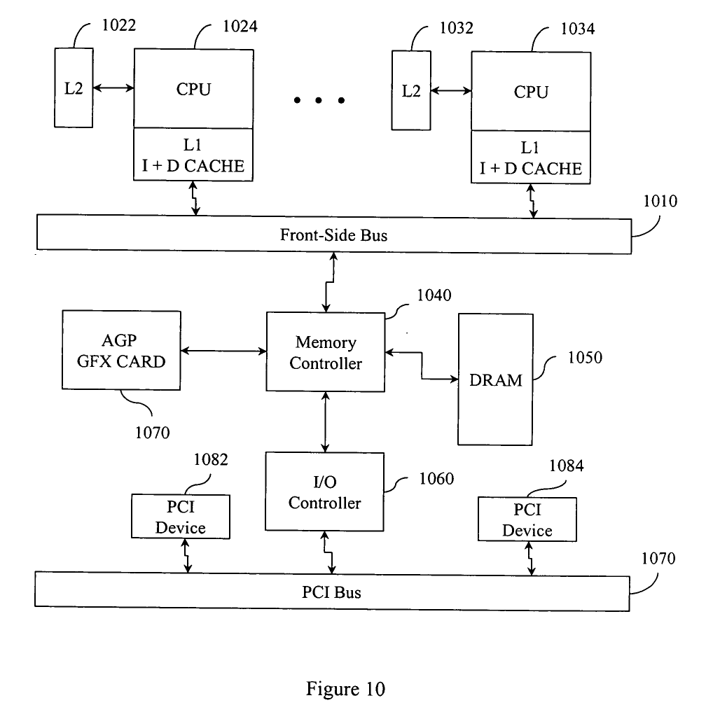

In the bus configuration illustrated in FIG. 1, transactions like memory reads, cache coherence operations and so on will be heard by substantially all the components (e.g., 120, 130, 140, 150) operably connected by the bus 110. Similarly, in the example multiprocessing system illustrated in FIG. 10, which uses a front-side bus, cache coherence operations may be heard by multiple computer components. For example, CPU 1024 and CPU 1034 may communicate through bus 1010 with a memory controller 1040. Thus a cache coherence operation involving a data line stored in, for example, the L1 cache of CPU 1024 may be seen by both CPU 1024 and CPU 1034.

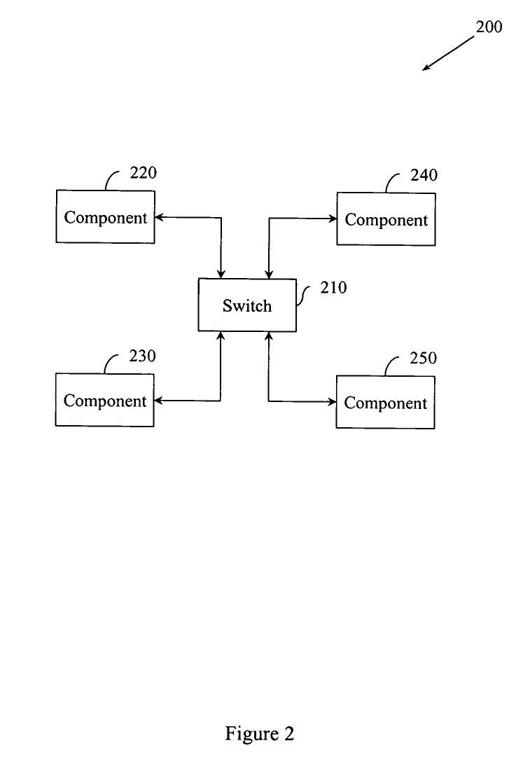

FIG. 2 illustrates an example set 200 of computer components arranged in a P2P configuration and connected by a switch 210 (e.g., a crossbar switch) The components 220, 230, 240, and 250 may be, for example, processors with caches. Once again, while four components are illustrated, it is to be appreciated that a switch(es) can connect a greater and/or lesser number of components in a P2P configuration. Transactions like memory reads, cache coherency requests and so on from a first component (e.g., 220) may be routed through the switch 210 to arrive at a second component (e.g., 230).

As described above, to implement a snooping cache coherence protocol a member of the set 200 would broadcast cache coherency transaction requests to all the components of the set 200. Thus, the bus configuration illustrated in FIG. 1 may be more typically associated with a snooping protocol while the P2P model configuration of set 200 may more typically be associated with a directory protocol. Rather than broadcasting a cache coherence request to all the components in the set 200, a cache coherence transaction may be sent to a single component that stores the directory. For example, component 250 could be responsible for maintaining the directory.

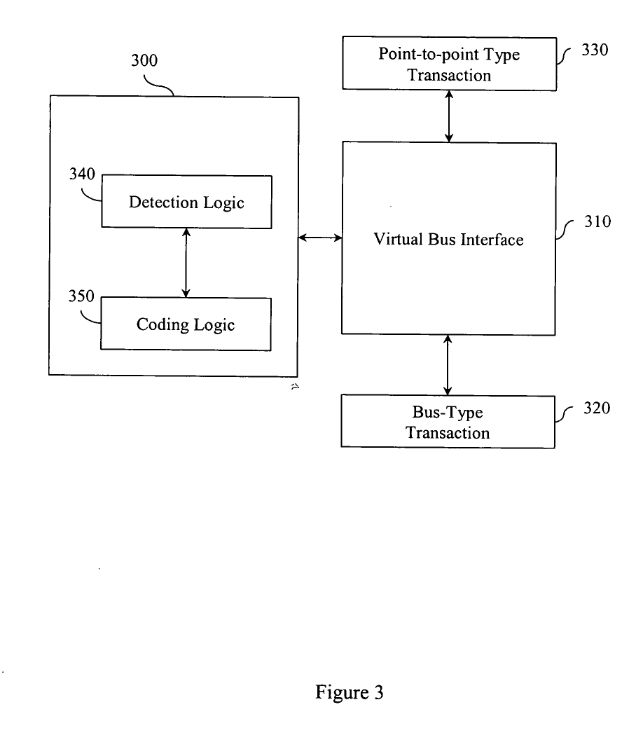

FIG. 3 illustrates an example system 300 for detecting a coherency protocol mode on a packet-by-packet basis. The system 300 may be configured to interact with a virtual bus interface 310 that produces a bus-type transaction 320 from a point-to-point type transaction 330. The system 300 may include a detection logic 340 that is operably connectable to the virtual bus interface 310. The detection logic 340 may be configured to detect a cache coherence protocol mode associated with a system that provides the point-to-point type transaction 330 to the virtual bus interface 310.

In one example, the detection logic 340 may be configured to determine the cache coherence protocol mode by referencing a state machine (not illustrated) that is configured to track transaction types encountered in a set of cache coherence transactions. The state machine may track, for example, a set of packets associated with a self-snoop request. The state machine may be updated, for example, by a packet tracking logic (not illustrated) associated with the virtual bus interface 310.

In another example, the detection logic 340 may be configured to determine the cache coherence protocol mode by determining whether a first transaction type initiated by a processor in the originating system that provided the point-to-point type transaction 330 is responded to with a second transaction type from a memory controller in the system. By way of illustration, the first transaction type may be a processor-initiated self-snoop request and the second transaction type may be a memory agent initiated self-snoop request. By way of further illustration, the first transaction type may be a data read transaction and the second transaction type may be a data invalid transaction.

The system 300 may also include a coding logic 350 that is operably connectable to the detection logic 340 and the virtual bus interface 310. The coding logic 350 may be configured to control how a cache coherence transaction received from the system that provided the point-to-point type transaction 330 is processed by the virtual bus interface 310. The control may be based, at least in part, on the cache coherence protocol mode detected by the detection logic 340. In one example, the detection logic 340 may be configured to initially assume that the cache coherence protocol mode is a directory-based protocol. Thus, the coding logic 350 may be configured to treat a port read line code self snoop (PRLCSS) request as a port read line code (PRLC) request until the detection logic 340 determines that the cache coherency protocol mode is a snooping protocol. The detection logic 340 may determine that the cache coherence protocol mode is a snooping protocol by determining that a port read line code self snoop request (PRLCSS) initiated by a processor is responded to by a self snoop request from a simple memory agent. Thus, upon the detection logic 340 determining that the cache coherence protocol mode is a snooping protocol, the coding logic 350 may treat the port read line code self snoop (PRLCSS) request previously treated as a port read line code (PRLC) request as a port read line code self snoop (PRLCSS) request. The coding logic 350 may internally manipulate transaction types while determining whether the semantics of bus phases are satisfied.

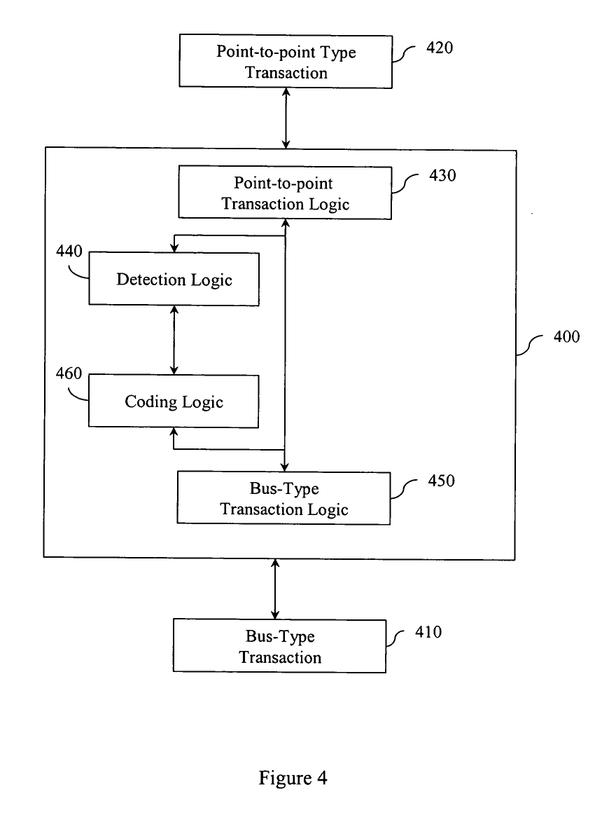

FIG. 4 illustrates an example virtual bus interface system 400 configured to produce a bus-type transaction 410 from a point-to-point type transaction 420, where the VBI 400 can detect a coherency protocol mode on a packet-by-packet basis. The VBI 400 may include a point-to-point transaction logic 430 that is configured to receive a packet associated with the point-to-point type transaction 420. The point-to-point type transaction 420 may be received from a point-to-point linked system that is operating with a directory or snooping cache coherence protocol.

The VBI 400 may also include a detection logic 440 that is configured to detect a cache coherence protocol mode associated with the point-to-point linked system that provided the point-to-point type transaction 420. In one example, the detection logic 440 may be configured to reference a state machine (not illustrated) that tracks transaction types encountered in a set of cache coherence transactions and/or the degree of completion of a transaction. The state machine facilitates determining whether a first transaction type initiated by a processor in the originating system is responded to with a second transaction type from a memory controller as recorded in the state machine. For example, the first transaction type may be a processor initiated self-snoop request and the second transaction type may be a simple memory agent initiated self-snoop request. The state machine may also facilitate determining whether the semantics of a bus phase are satisfied.

The VBI 400 may also include a bus-type transaction logic 450 that is configured to selectively produce the bus-type transaction 410 from the point-to-point type transaction 420 received by the point-to-point transaction logic 430. As described above, there may not be a one to one semantic mapping between the point-to-point type transaction 420 and the bus-type transaction 410 based on differences between P2P systems and bus systems, differences between snooping and directory cache coherence protocols, and so on.

Thus, the VBI 400 may include a coding logic 460 that is configured to control how a cache coherence transaction received from the point-to-point linked system is processed by the bus-type transaction logic 450 based, at least in part, on the cache coherence protocol mode detected by the detection logic 440. In response to detecting a cache coherence protocol, the coding logic 460 may control the bus-type transaction logic 450 by performing actions like indicating to the bus-type transaction logic 450 that the semantics of a bus phase have been satisfied, indicating to the bus-type transaction logic 450 that the semantics of a bus phase have not been satisfied, and so on.

In one example, the detection logic 440 may be configured to initially assume that the cache coherence protocol mode is a directory-based protocol. Additionally, the coding logic 460 may be configured to initially treat a port read line code self snoop (PRLCSS) request as a port read line code (PRLC) request. Then, if the detection logic 440 determines that the cache coherency protocol mode associated with the provider of the point-to-point type transaction 420 is a snooping protocol by determining that a port read line code self snoop request (PRLCSS) initiated by a processor is responded to by a self snoop request from a simple memory agent, the coding logic 460 can be dynamically reconfigured to treat the port read line code self snoop (PRLCSS) request previously treated as a port read line code (PRLC) request as a port read line code self snoop (PRLCSS) request.

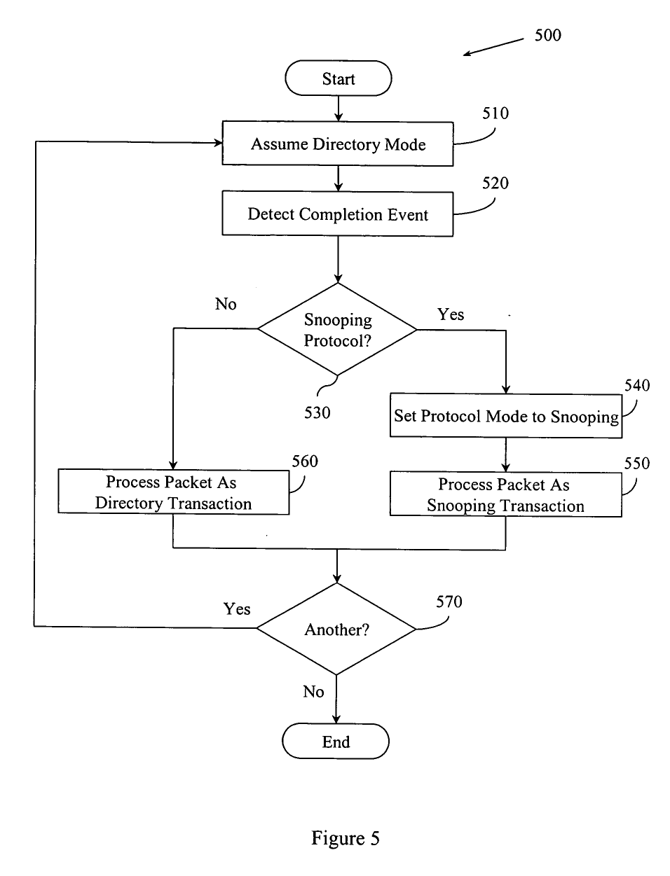

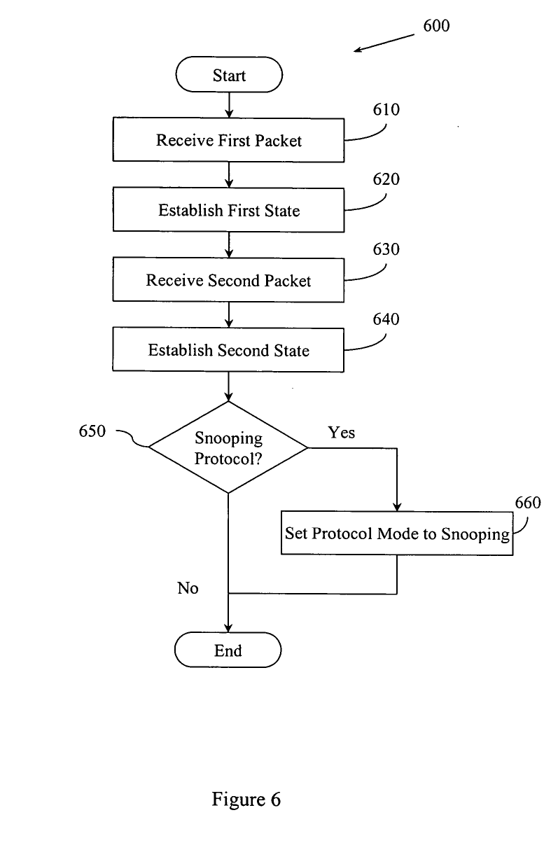

Example methods may be better appreciated with reference to the flow diagrams of FIGS. 5 and 6. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Furthermore, additional and/or alternative methodologies can employ additional, not illustrated blocks.

In the flow diagram, blocks denote “processing blocks” that may be implemented with logic. A flow diagram does not depict syntax for any particular programming language, methodology, or style (e.g., procedural, object-oriented). Rather, a flow diagram illustrates functional information one skilled in the art may employ to develop logic to perform the illustrated processing. It will be appreciated that in some examples, program elements like temporary variables, routine loops, and so on are not shown. It will be further appreciated that electronic and software applications may involve dynamic and flexible processes so that the illustrated blocks can be performed in other sequences that are different from those shown and/or that blocks may be combined or separated into multiple components. It will be appreciated that the processes may be implemented using various programming approaches like machine language, procedural, object oriented and/or artificial intelligence techniques.

FIG. 5 illustrates an example method 500 for detecting a coherency protocol mode on a packet-by-packet basis in a virtual bus interface. The method 500 may include, at 510, configuring a memory location to assume that a cache coherence protocol mode in use by a point-to-point system is a directory mode. At 520, a completion event associated with a point-to-point transaction being received in a virtual bus interface can be detected. After the completion event is detected a determination can be made at 530 concerning whether the cache coherency protocol mode associated with a system producing the point-to-point transaction is a snooping or directory based mode. Making the determination at 530 may include actions like those illustrated in FIG. 6. Thus, actions like manipulating and referencing a state machine and/or a transaction tracking logic can facilitate determining the cache coherence protocol. For example, if a first transaction type is responded to with a second transaction type, this may indicate a snooping protocol while if the first transaction type is responded to with a third transaction type this may indicate a directory protocol.

If the determination at 530 is Yes, that a snooping protocol is indicated, then the method 500 may proceed, at 540 to reconfigure the memory location to indicate that the cache coherence protocol mode is a snooping mode. At 550, the packet may be processed as though it were associated with a system employing a snooping cache coherence protocol mode. But if the determination at 530 is No, that snooping is not detected, then the method 500 may proceed, at 560, to process the packet as though it were associated with a system employing a directory-based cache coherence protocol. Thus, a packet associated with the point-to-point transaction may be selectively processed into a bus-type transaction. Selectively processing a packet associated with the point-to-point transaction into a bus-type transaction based, at least in part, on the cache coherency protocol detected may involve actions including, but not limited to, determining that a packet satisfies the semantics of a bus phase, determining that a packet does not satisfy the semantics of a bus phase, changing the type of a packet, and so on.

At 570 a determination may be made concerning whether there is another packet and/or transaction to process. If the determination is Yes, then processing can return to 510, otherwise processing may conclude.

While FIG. 5 illustrates various actions occurring in serial, it is to be appreciated that various actions illustrated in FIG. 5 could occur substantially in parallel. By way of illustration, a first process could detect completion events while a second process could determine whether a snooping protocol is indicated, and a third process could selectively process packets associated with a point-to-point type transaction into a bus-type transaction. While three processes are described, it is to be appreciated that a greater and/or lesser number of processes could be employed and that lightweight processes, regular processes, threads, and other approaches could be employed.

In one example, methodologies are implemented as processor executable instructions and/or operations stored on a computer-readable medium. Thus, in one example, a computer-readable medium may store processor executable instructions operable to perform a method for detecting a cache coherency protocol on a packet-by-packet basis. The method may include setting a cache coherency protocol mode to a directory mode and detecting a completion event associated with a point-to-point transaction being received in a virtual bus interface. Upon detecting the completion event, the method may include determining the cache coherency protocol mode associated with the system producing the point-to-point transaction by, for example, establishing a first state in response to receiving a first packet associated with the point-to-point transaction and selectively establishing a second state in response to receiving a second packet associated with the point-to-point transaction, where the second packet is generated by the system producing the point-to-point transaction in response to the first packet. Then, the method may include selectively resetting the cache coherence protocol mode to a snooping mode based, at least in part, on the second state that is established. After the second state is established, the method may include selectively processing a packet associated with the point-to-point transaction into a packet associated with a bus-type transaction based, at least in part, on the cache coherency protocol. Selectively processing the transaction may include, determining that a packet satisfies the semantics of a bus phase, determining that a packet does not satisfy the semantics of a bus phase, changing the type of a packet, and so on.

While the above method is described being stored on a computer-readable medium, it is to be appreciated that other example methods described herein can also be stored on a computer-readable medium.

FIG. 6 illustrates a portion 600 of a method associated with detecting a coherency protocol mode in a virtual bus interface. The portion 600 concerns a determination being made about whether a cache coherency protocol mode associated with a system producing a point-to-point transaction to be processed into a bus-type transaction is using a snooping or directory based cache coherency protocol.

The portion 600 may include, at 610, receiving a first packet associated with the transaction. The portion 600 includes, at 620, establishing a first state in response to receiving the first packet. For example, if a processor initiated self-snoop request is received at 610, then the first state established at 620 may concern determining whether the next packet received is a data packet or a self-snoop request initiated by a memory controller or a simple memory agent.

The portion 600 may then proceed, at 630, to receive a second packet and, at 640, to establish a second state in response to receiving the second packet associated with the point-to-point transaction. The second packet may be generated by the system producing the point-to-point transaction in response to the first packet. For example, the second packet may be a data value provided in response to a data read, may be a “data invalid” packet provided in response to a data read, and so on.

At 650, a determination is made concerning whether the second state indicates that a snooping protocol has been detected. If the determination at 650 is Yes, then at 660 the cache coherence protocol mode may be reset to a snooping mode.

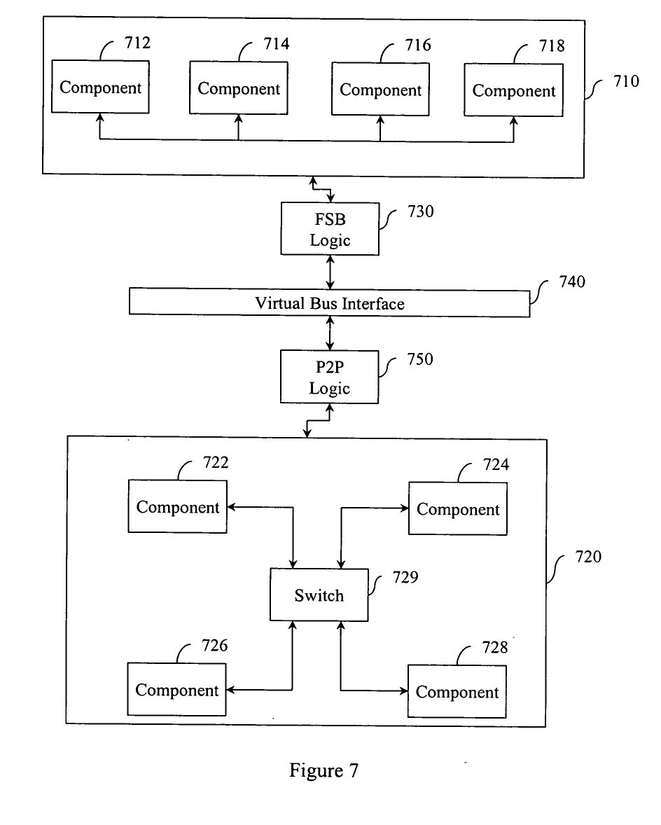

FIG. 7 illustrates a system 700 that includes both an FSB subsystem 710 and a P2P subsystem 720. The FSB subsystem 710 may include, for example, computer components (e.g., processors with caches) like components 712, 714, 716, and 718 that are connected by a bus. The P2P subsystem 720 may similarly include, for example, computer components (e.g., processors with caches) like components 722, 724, 726, and 728 that are connected by a switch 729. While four components are illustrated in each subsystem and while two subsystems are illustrated, it is to be appreciated that a greater and/or lesser number of components and/or subsystems may be employed.

The FSB subsystem 710 may be operably connected to an FSB logic 730 that is in turn operably connected to a VBI 740. Similarly, the P2P subsystem 720 may be operably connected to a P2P logic 750 that is in turn operably connected to the VBI 740. The FSB logic 730 may, for example, provide FSB transactions from the FSB subsystem 710 to the VBI 710 and/or receive FSB transactions from the VBI 740. Similarly, the P2P logic 750 may, for example, provide P2P transactions to the VBI 740 and/or receive P2P transactions from the VBI 740. This example multiprocessing system 700, which includes both bus connected components and P2P link connected components may be a system in which example systems and methods described herein may be employed. For example, to facilitate communications between the FSB subsystem 710 and the P2P subsystem 720, the VBI 740 may be configured to process P2P transactions to bus-type transactions and vice versa. As part of processing P2P transactions to bus-type transactions, the VBI 740 may be configured to detect a cache coherency protocol being employed by an originating subsystem. Thus, the VBI 740 may more accurately track coherence transactions and in turn more accurately produce transactions.

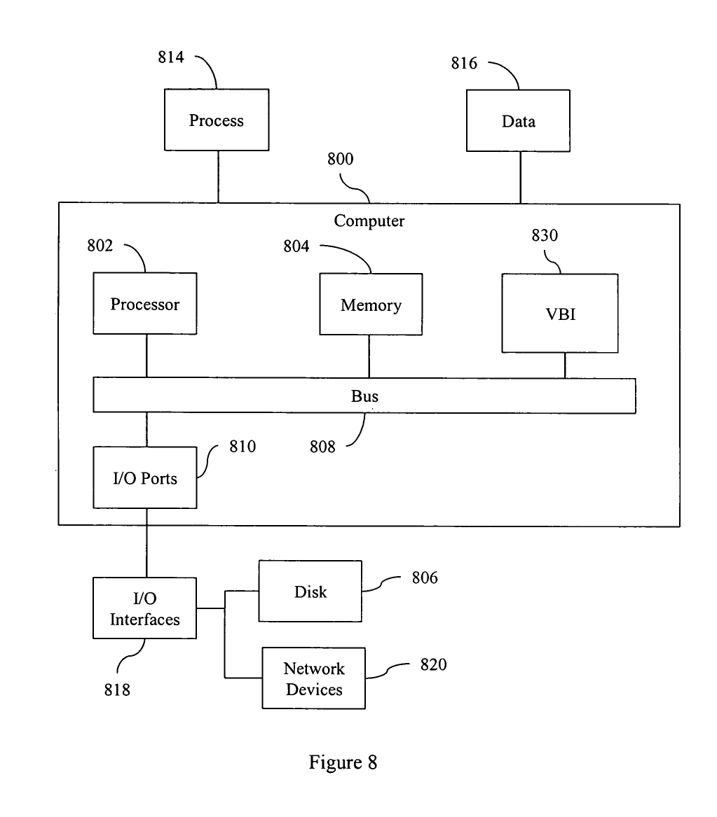

FIG. 8 illustrates a computer 800 that includes a processor 802, a memory 804, and input/output ports 810 operably connected by a bus 808. In one example, the computer 800 may include a VBI 830 configured to facilitate converting P2P transactions into bus-type transactions. The VBI 830 may be configured similar to example systems and methods described herein to facilitate detecting a coherency protocol mode employed by a transaction originating system and, upon determining the coherency protocol mode being employed, to selectively alter how packets are processed into transactions.

Thus, the VBI 830, whether implemented in computer 800 as hardware, firmware, software, and/or a combination thereof may provide means for receiving a packet associated with a point-to-point transaction, for detecting a cache coherency protocol mode based, at least in part, on the packet and for selectively producing a bus type transaction from the point-to-point transaction. The producing may be controlled, at least in part, by the cache coherency protocol mode detected.

The processor 802 can be a variety of various processors including dual microprocessor and other multi-processor architectures. The memory 804 can include volatile memory and/or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM).

A disk 806 may be operably connected to the computer 800 via, for example, an input/output interface (e.g., card, device) 818 and an input/output port 810. The disk 806 can include, but is not limited to, devices like a magnetic disk drive, a solid state disk drive, a floppy disk drive, a tape drive, a Zip drive, a flash memory card, and/or a memory stick.

Furthermore, the disk 806 can include optical drives like a CD-ROM, a CD recordable drive (CD-R drive), a CD rewriteable drive (CD-RW drive), and/or a digital video ROM drive (DVD ROM). The memory 804 can store processes 814 and/or data 816, for example. The disk 806 and/or memory 804 can store an operating system that controls and allocates resources of the computer 800.

The bus 808 can be a single internal bus interconnect architecture and/or other bus or mesh architectures. While a single bus is illustrated, it is to be appreciated that computer 800 may communicate with various devices, logics, and peripherals using other busses that are not illustrated (e.g., PCIE, SATA, Infiniband, 1394, USB, Ethernet). The bus 808 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 800 may interact with input/output devices via i/o interfaces 818 and input/output ports 810. Input/output devices can include, but are not limited to, a keyboard, a microphone, a pointing and selection device, cameras, video cards, displays, disk 806, network devices 820, and the like. The input/output ports 810 can include but are not limited to, serial ports, parallel ports, and USB ports.

The computer 800 can operate in a network environment and thus may be connected to network devices 820 via the i/o devices 818, and/or the i/o ports 810. Through the network devices 820, the computer 800 may interact with a network. Through the network, the computer 800 may be logically connected to remote computers. The networks with which the computer 800 may interact include, but are not limited to, a local area network (LAN), a wide area network (WAN), and other networks. The network devices 820 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), and the like. Similarly, the network devices 820 can connect to WAN technologies including, but not limited to, point to point links, circuit switching networks like integrated services digital networks (ISDN), packet switching networks, and digital subscriber lines (DSL).

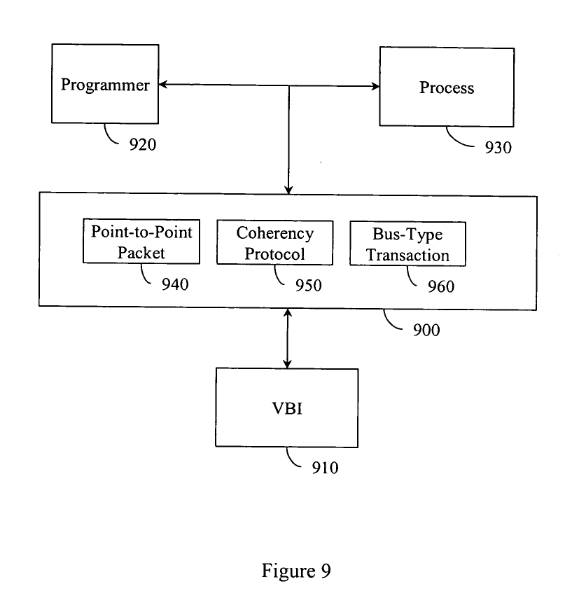

Referring now to FIG. 9, an application programming interface (API) 900 is illustrated providing access to a VBI 910. The API 900 can be employed, for example, by a programmer 920 and/or a process 930 to gain access to processing performed by the VBI 910. For example, a programmer 920 can write a program to access the VBI 910 (e.g., invoke its operation, monitor its operation, control its operation) where writing the program is facilitated by the presence of the API 900. Rather than programmer 920 having to understand the internals of the VBI 910, the programmer 920 merely has to learn the interface to the VBI 910. This facilitates encapsulating the functionality of the VBI 910 while exposing that functionality.

Similarly, the API 900 can be employed to provide data values to the VBI 910 and/or retrieve data values from the VBI 910. For example, a process 930 that parses point-to-point packets can provide a point-to-point type packet to the system 910 via the API 900 by, for example, using a call provided in the API 900. In one example, a set of application programming interfaces can be stored on a computer-readable medium to facilitate detecting a coherency protocol mode in a virtual bus interface. The interfaces can be employed by a programmer, computer component, logic, and so on to gain access to VBI 910. The interfaces can include, but are not limited to, a first interface 940 that communicates a point-to-point type packet, a second interface 950 that communicates a coherency protocol data, and a third interface 960 that communicates a bus-type transaction selectively processed from point-to-point packets based on the coherency protocol data.

FIG. 10 illustrates an example system that employs a front-side bus 1010. The system may include a set of CPUs (e.g., CPU 1024 through CPU 1034). While two CPUs are illustrated, it is to be appreciated that a greater and/or lesser number of CPUs may be employed. The CPUs may include an L1 cache that stores, for example, instructions and data. Similarly, the CPUs may include an L2 cache (e.g., L2 caches 1022 through 1032). Data and/or instructions may be transferred between the L1 caches and L2 caches.

In one example, CPU 1024 and CPU 1034 may communicate. This may involve an operation(s) involving the front-side bus 1010. How and/or when the CPUs communicate may be controlled, at least in part, by the cache coherency protocol in effect in the system. Similarly, CPU 1024 may interact with a memory controller 1040, which may also involve an operation(s) on the front-side bus 1010, where the operation is influenced, at least in part, by the cache coherency protocol. The memory controller 1040 may provide access to, for example, a dynamic RAM 1050, an I/O controller 1060, a graphics card 1070, and so on. The I/O controller 1060 may also provide access to a set of PCI devices (e.g., PCI devices 1082, 1084) via a PCI bus 1070. Once again, operations involving the memory controller 1040 may be affected by a cache coherency protocol employed by the system.

The system illustrated in FIG. 10 may be a system for which a component (e.g., CPU 1024, CPU 1034) is simulated. For example, CPU 1024 may be simulated by tools like an RTL tool, a golden simulator, and so on. The tools may not include a bus like front-side bus 1010, but rather may be connected by a network model. Thus, a virtual bus interface like those described above may be tasked with facilitating communication between front-side bus model systems and network model systems. One action involved in facilitating this communication may be detecting a cache coherency protocol employed in the system(s), to facilitate producing bus phases and/or transactions appropriately.

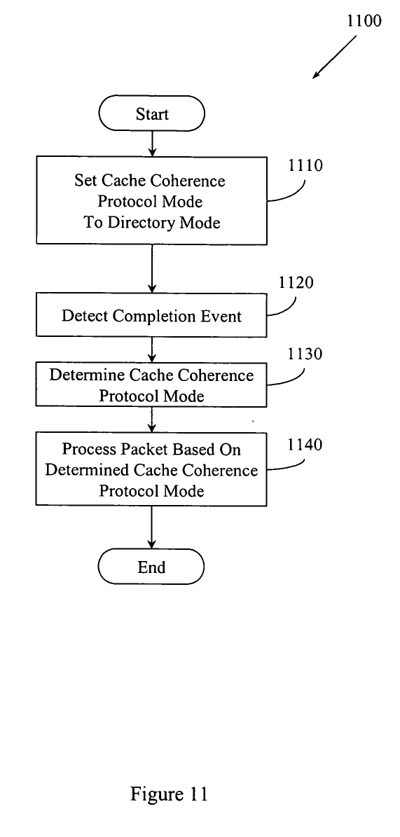

FIG. 11 illustrates a method 1100 that includes, at 1110, setting a cache coherence protocol mode to a directory mode. The method 1100 also includes, at 1120, detecting a completion event associated with a point-to-point transaction being received in a virtual bus interface. After the completion event is detected, the method 1100 proceeds, at 1130, to determine the cache coherency protocol mode associated with a system producing the point-to-point transaction. Determining the cache coherency protocol may include examining a set of packets associated with the point-to-point transaction. In one example, determining the cache coherency protocol mode at 1130 may include establishing a first state in response to receiving a first packet associated with the point-to-point transaction and then selectively establishing a second state in response to receiving a second packet associated with the point-to-point transaction, where the second packet is generated by the system producing the point-to-point transaction in response to the first packet. Determining the cache coherency protocol mode at 1130 may also include selectively resetting the cache coherence protocol mode to snooping mode based, at least in part, on the second state. The method 1100 may conclude, at 1140, by selectively processing a packet associated with the point-to-point transaction into a bus-type transaction based. How the packet is processed depends, at least in part, on the cache coherency protocol determined at 1130.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the tern “or” herein is the inclusive, and not the exclusive use. See, Bryan A. Garner, A Dictionary of Modem Legal Usage 624 (2d. Ed. 1995).

1. A system configured to interact with a virtual bus interface that produces a bus-type transaction from a point-to-point type transaction, the system comprising:
a detection logic operably connectable to the virtual bus interface, the detection logic being configured to detect a cache coherence protocol mode associated with an originating system that provides the point-to-point type transaction to be processed by the virtual bus interface; and
a coding logic operably connectable to the detection logic and the virtual bus interface, the coding logic being configured to control how a cache coherence transaction received from the originating system is processed by the virtual bus interface based, at least in part, on the cache coherence protocol mode detected by the detection logic.

2. The system of claim 1, where the detection logic is configured to determine the cache coherence protocol mode by referencing a state machine configured to track transaction types encountered in a set of cache coherence transactions.

3. The system of claim 1, where the detection logic is configured to determine the cache coherence protocol mode by determining whether a first transaction type initiated by a processor in the originating system is responded to with a second transaction type from a memory controller in the originating system.

4. The system of claim 3, where the first transaction type comprises a processor-initiated self-snoop request and the second transaction type comprises a memory agent initiated self-snoop request.

5. The system of claim 3, where the first transaction type comprises a data read transaction and the second transaction type comprises a data invalid transaction.

6. The system of claim 1, the detection logic being configured to initially assume that the cache coherence protocol mode is a directory-based protocol.

7. The system of claim 6, the coding logic being configured to treat a port read line code self snoop (PRLCSS) request as a port read line code (PRLC) request until the detection logic determines that the cache coherency protocol mode is a snooping protocol.

8. The system of claim 7, where the detection logic determines that the cache coherence protocol mode is a snooping protocol by determining that a port read line code self snoop request (PRLCSS) initiated by a processor is responded to by a self snoop request from a simple memory agent.

9. The system of claim 8, where upon the detection logic determining that the cache coherence protocol mode is a snooping protocol, the coding logic is dynamically reconfigured to treat the port read line code self snoop (PRLCSS) request previously treated as a port read line code (PRLC) request as a port read line code self snoop (PRLCSS) request.

10. A virtual bus interface system configured to produce a bus-type transaction from a point-to-point type transaction, comprising:
a point-to-point transaction logic configured to receive a packet associated with a point-to-point transaction from a point-to-point linked system;
a detection logic configured to detect a cache coherence protocol mode associated with the point-to-point linked system by examining a set of packets associated with the point-to-point type transaction;
a bus-type transaction logic configured to selectively produce a bus-type transaction from a point-to-point transaction received by the point-to-point transaction logic; and
a coding logic configured to control how a transaction received from the point-to-point linked system is processed by the bus-type transaction logic based, at least in part, on the cache coherence protocol mode detected by the detection logic.

11. The system of claim 10, where the detection logic is configured to reference a state machine that is configured to track transaction types encountered in a set of cache coherence transactions and to determine whether a first transaction type initiated by a processor in the originating system is responded to with a second transaction type from a memory controller.

12. The system of claim 11, where the first transaction type comprises a processor initiated self-snoop request and the second transaction type comprises a simple memory agent initiated self-snoop request.

13. The system of claim 12, the detection logic being configured to initially assume that the cache coherence protocol mode is a directory-based protocol.

14. The system of claim 13, the coding logic being configured to treat a port read line code self snoop (PRLCSS) request as a port read line code (PRLC) request until the detection logic determines that the cache coherency protocol mode is a snooping protocol, and upon the detection logic determining that the cache coherence protocol mode is a snooping protocol by determining that a port read line code self snoop request (PRLCSS) initiated by a processor is responded to by a self snoop request from a simple memory agent treating the port read line code self snoop (PRLCSS) request previously treated as a port read line code (PRLC) request as a port read line code self snoop (PRLCSS) request.

15. A method, comprising:
setting a cache coherence protocol mode to a directory mode;
detecting a completion event associated with a point-to-point transaction being received in a virtual bus interface;
determining the cache coherency protocol mode associated with a system producing the point-to-point transaction by examining a set of packets associated with the point-to-point transaction; and
selectively processing a packet associated with the point-to-point transaction into a bus-type transaction based, at least in part, on the cache coherency protocol determined.

16. The method of claim 15, where determining the cache coherency protocol mode includes:
establishing a first state in response to receiving a first packet associated with the point-to-point transaction;
selectively establishing a second state in response to receiving a second packet associated with the point-to-point transaction, where the second packet is generated by the system producing the point-to-point transaction in response to the first packet; and
selectively resetting the cache coherence protocol mode to snooping mode based, at least in part, on the second state.

17. A computer-readable medium storing processor executable instructions operable to perform a method, the method comprising:
setting a cache coherency protocol mode to a directory mode;
detecting a completion event associated with a point-to-point transaction being received in a virtual bus interface;
determining the cache coherency protocol mode associated with the system producing the point-to-point transaction by:
establishing a first state in response to receiving a first packet associated with the point-to-point transaction;
selectively establishing a second state in response to receiving a second packet associated with the point-to-point transaction, where the second packet is generated by the system producing the point-to-point transaction in response to the first packet; and
selectively resetting the cache coherence protocol mode to a snooping mode based, at least in part, on the second state; and
selectively processing a packet associated with the point-to-point transaction into a bus-type transaction based, at least in part, on the cache coherency protocol detected.

18. A system, comprising:
means for receiving a packet associated with a point-to-point transaction;
means for detecting a cache coherency protocol mode based, at least in part, on the packet; and
means for selectively producing a bus-type transaction from the point-to-point transaction, where the producing is controlled, at least in part, by the cache coherency protocol mode detected.

19. A set of application programming interfaces embodied on a computer-readable medium for execution by a computer component in conjunction with detecting a coherency protocol mode in a virtual bus interface, comprising:
a first interface for communicating a point-to-point type packet;
a second interface for communicating a cache coherency protocol mode data; and
a third interface for communicating a bus-type packet selectively processed from the point-to-point packet, where the bus-type packet processing depends, at least in part, on the cache coherency protocol mode data.
